(19) United States
(12) Patent Application Publication
(10) Pub. No.: US 2025/0221459 A1
(43) Pub. Date: Jul. 10, 2025

(54) AEROSOL GENERATING DEVICE AND METHOD FOR CONTROLLING THE SAME

(71) Applicant: KT&G CORPORATION, Daejeon (KR)

(72) Inventors: Sangkyu PARK, Seoul (KR); Daenam HAN, Seoul (KR); Hanseul RYU, Seoul (KR); Hwikyeong AN, Seoul (KR); Jaemin LEE, Siheung-si Gyeonggi-do (KR)

(73) Assignee: KT&G CORPORATION, Daejeon (KR)

(21) Appl. No.: 18/850,866

(22) PCT Filed: Mar. 31, 2023
(86) PCT No.: PCT/KR2023/004364

§ 371 Date: Sep. 25, 2024

(30) Foreign Application Priority Data
Apr. 1, 2022 (KR) 10-2022-0041258

(51) Int. Cl. A24F 40/465; A24F 40/20; A24F 40/53; A24F 40/57; H01F 27/28; H05B 6/06; H05B 6/10; H05B 6/44

(52) U.S. Cl. CPC A24F 40/465; A24F 40/20; A24F 40/53; A24F 40/57; H05B 6/065; H05B 6/105; H05B 6/44; H01F 27/28

(57) ABSTRACT

An aerosol generating device configured to receive a stick including an aerosol generating substance and a susceptor, wherein the aerosol generating device includes: a plurality of coils configured to inductively heat the susceptor in the stick; and a controller configured to apply, based on measured values flowing through each of the plurality of coils when a reference voltage is applied to the plurality of coils, a voltage to at least one of the plurality of coils having a measured current value less than or equal to a predetermined reference current value.

### TECHNICAL FIELD

The present disclosure relates to an aerosol generating device and a method for controlling the aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to inductively heat a susceptor in an efficient manner by controlling a voltage applied to a plurality of coils.

It is yet another objective of the present disclosure to inductively heat a susceptor by using at least one coil among a plurality of coils, so as to correspond to a disposition direction of the susceptor.

### Solution to Problem

According to one aspect of the subject matter described in this application, an aerosol generating device configured to receive a stick comprising an aerosol generating substance and a susceptor, the aerosol generating device comprising: a housing comprising an opening to an inner wall defining therein an insertion space configured to accommodate insertion of the stick, wherein the housing further comprises an outer wall surrounding the inner wall; a plurality of coils disposed between the inner wall and the outer wall of the housing and configured to inductively heat the susceptor inserted in the insertion space; a power source electrically connected to the plurality of coils; and a controller configured to: cause the power source to apply a reference voltage to the plurality of coils; measure respective current values flowing through each of the plurality of coils based on the reference voltage; and cause the power source to apply a voltage to at least one coil of the plurality of coils having the measured current value less than or equal to a predetermined reference current value.

### Advantageous Effects of Invention

According to at least one of the embodiments of the present disclosure, a susceptor may be inductively heated in an efficient manner by controlling a voltage applied to a plurality of coils.

According to at least one of the embodiments of the present disclosure, electrical energy consumed by a plurality of coils may be reduced by controlling a voltage applied to the plurality of coils.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 12 illustrate examples of an aerosol generating device.

FIGS. 13 to 17 illustrate examples of a method for controlling an aerosol generating device.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

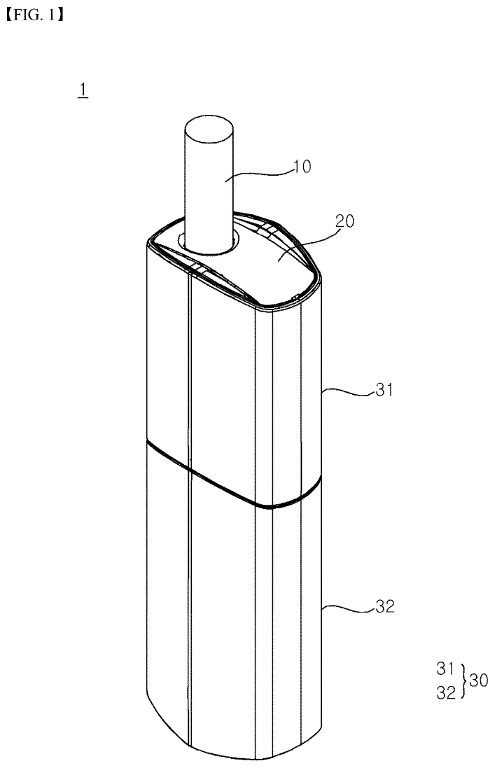

FIG. 1 is a perspective view of an aerosol generating device 1 according to an embodiment of the present disclosure.

Referring to FIG. 1, an aerosol generating device 1 may include a casing 30 that includes an upper part 31 and a lower part 32, and a cap 20 that is coupled to the upper part 31.

A stick 10 may have an elongated shape. For example, the stick 10 may be formed in a cylindrical shape. A portion of the stick 10 may be inserted into the aerosol generating device 1 through the cap 20. The remaining portion of the stick 10 may be positioned outside the aerosol generating device 1.

The casing 30 may include the upper part 31 and the lower part 32. The upper part 31 and the lower part 32 may define an outer surface of the aerosol generating device 1. An outer surface of the upper part 31 and an outer surface of the lower part 32 may form a continuous surface.

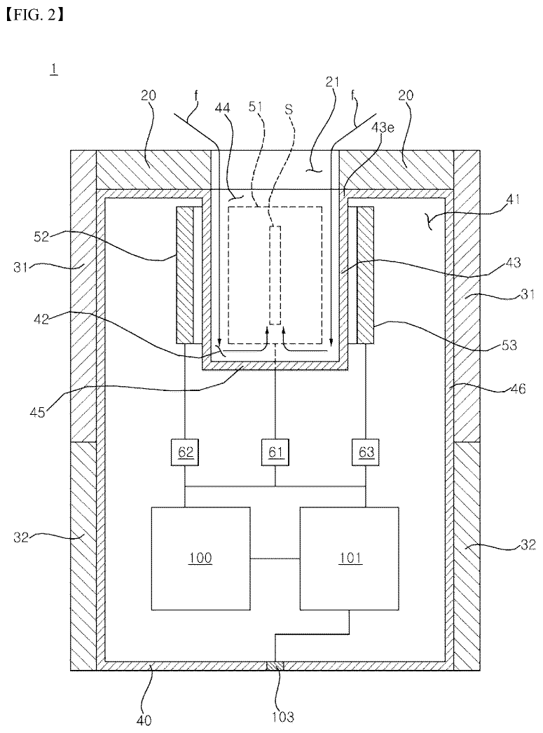

The cap 20 may have a hole 21 (see FIG. 2) into which the stick 10 is inserted. The cap 20 may be coupled to the upper part 31. The hole 21 of the cap 20 may communicate with an insertion space 42 (see FIG. 2) into which the stick 10 is inserted.

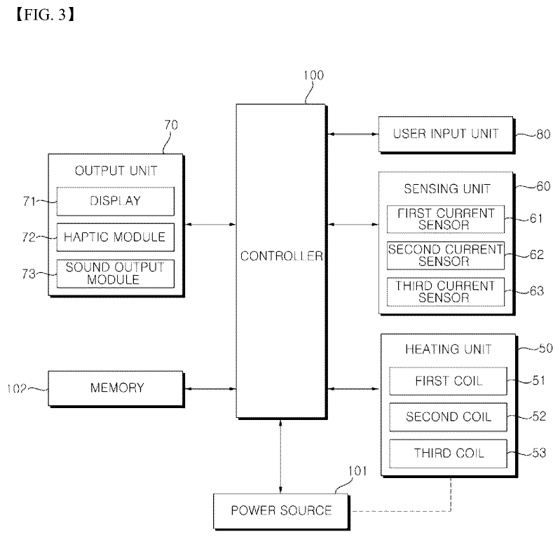

FIG. 2 is a cross-sectional view of the aerosol generating device 1 according to an embodiment of the present disclosure. FIG. 3 is a block diagram of the aerosol generating device 1 according to an embodiment of the present disclosure.

Referring to FIGS. 1 to 3, the aerosol generating device 1 may include a housing 40, a heating unit 50, a sensing unit 60, an output unit 70, a user input unit 80, and a controller 100.

The housing 40 may be disposed inside the casing 30. The housing 40 may be coupled to the cap 20. The housing 40 may be coupled to the upper part 31 and the lower part 32. The housing 40 may be made of a non-conductive material. The housing 40 may be provided therein with the heating unit 50, the sensing unit 60, and the controller 100. The housing 40 may include an inner wall (43, 45), and an outer wall 46.

The inner wall (43, 45) may include a lateral part 43 and a base part 45. The inner wall (43, 45) may have an insertion space 42 therein. One end 43e of the inner wall (43, 45) may be open. An opening 44 of the inner wall (43, 45) may communicate with the hole 21 of the cap 20. The stick 10 may be inserted into the insertion space 42 through the opening 44 of the inner wall (43, 45). The opening 44 of the inner wall (43, 45) may face the base part 45.

The base part 45 may support the stick 10 that is inserted into the insertion space 42. For example, one surface of the base part 45 facing the opening 44 may be formed flat. The base part 45 may be connected to the lateral part 43. The lateral part 43 may extend from the base part 45 in an elongated manner. For example, the lateral part 43 may have a cylindrical shape. The opening 44 may be formed at the one end 43e of the lateral part 43.

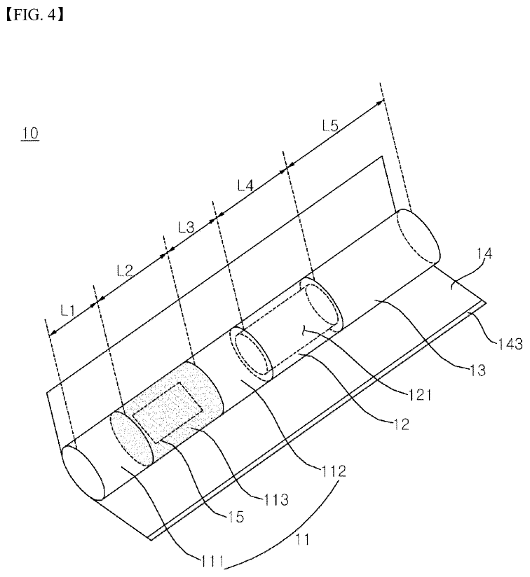

The insertion space 42 may be formed inside the inner wall (43, 45). The insertion space 42 may have a shape elongated along the inner wall (43, 45). A portion of the stick 10 may be inserted into the insertion space 42 through the hole 21 of the cap 20 and the opening 44 of the inner wall (43, 45). A susceptor 15 (see FIG. 4) of the inserted stick 10 may be disposed in a portion S of the insertion space 42.

Meanwhile, air f outside the aerosol generating device 1 may be introduced into the insertion space 42 through the hole 21 of the cap 20. The air f introduced into the insertion space 42 may flow into the stick 10 through a gap between the inner wall (43, 45) and the inserted stick 10.

The outer wall 46 of the housing 40 may surround the inner wall (43, 45). The outer wall 46 may be connected to the inner wall (43, 45). The outer wall 46 may be integrally formed with the inner wall (43, 45). A terminal 103 that is connected to a power source 101 may be disposed at the outer wall 46. The outer wall 46 may be coupled to the casing 30 and the cap 20. An accommodation space 41 defined by the outer wall 46 may be provided between the inner wall (43, 45) and the outer wall 46. The outer wall 46 may have a shape elongated along a longitudinal direction of the lateral part 43 of the inner wall (43, 45).

The heating unit 50 may include a plurality of coils 51, 52, and 53. The plurality of coils 51, 52, and 53 may include a first coil 51, a second coil 52, and a third coil 53. Herein, three coils are used as an example for description. However, this is for ease of explanation, and the number of coils is not limited to three. Thus, the idea and technical scope of the present disclosure are not limited to this example.

The plurality of coils 51, 52, and 53 may be arranged sequentially. The plurality of coils 51, 52, and 53 may surround the lateral part 43 of the inner wall (43, 45). The plurality of coils 51, 52, and 53 may be disposed adjacent to the inner wall (43, 45). The plurality of coils 51, 52, and 53 may face the lateral part 43 of the inner wall (43, 45). For example, the plurality of coils 51, 52, and 53 may be arranged on a single flexible printed circuit board (FPCB).

The first coil 51, the second coil 52, and the third coil 53 may be disposed in the accommodating space 41. The power source 101 may apply an AC voltage to the first coil 51, the second coil 52, and the third coil 53. The first coil 51, the second coil 52, and the third coil 53 may each generate an induced magnetic field therearound. The first coil 51, the second coil 52, and the third coil 53 may inductively heat the susceptor 15.

The heating unit 50 may be electrically connected to the power source 101. The heating unit 50 that is supplied with electrical energy from the power source 101 may heat the susceptor 15. The heating unit 50 may be connected to the controller 100. The heating unit 50 may be connected to the sensing unit 60.

The sensing unit 60 may include a first current sensor 61, a second current sensor 62, and a third current sensor 63. The first current sensor 61 may be connected to the first coil 51. The second current sensor 62 may be connected to the second coil 52. The third current sensor 63 may be connected to the third coil 53. The first current sensor 61 may measure a current value flowing through the first coil 51. The second current sensor 62 may measure a current value flowing through the second coil 52. The third current sensor 63 may measure a current value flowing through the third coil 53.

The output unit 70 may output information regarding the state (or status) of the aerosol generating device 1 to the outside. For example, the output unit 70 may provide information on whether the heating unit 50 needs to be replaced and on whether the power source 101 is charged.

The output unit 70 may include at least one of a display 71, a haptic module 72, and a sound output module 73, but the present disclosure is not limited thereto. For example, when the display 71 and a touch pad form a layered structure to implement a touch screen, the display 71 may be used as an input device in addition to an output device.

The display 71 may provide a user with information regarding the aerosol generating device 1 in a visual manner. For example, information regarding the aerosol generating device 1 may include various types of information such as the charging/discharging state of the power source 101 of the aerosol generating device 1, the insertion/removal state of the stick 10, or a state in which use of the aerosol generating device 1 is limited (e.g., detection of an abnormal item). The display 71 may output the various types of information to the outside. For example, the display 71 may be a liquid crystal display (LCD) panel, an organic light-emitting display (OLED) panel, or a light-emitting device (LED).

The haptic module 72 may convert an electrical signal into a mechanical or electrical stimulus to thereby provide the user with information regarding the aerosol generating device 1 in a tactical manner. For example, the haptic module 72 may include a motor, a piezoelectric element, or an electrical stimulation device.

The sound output module 73 may provide the user with information regarding the aerosol generating device 1 in an audible manner. For example, the sound output module 73 may convert an electrical signal into a sound signal to be output to the outside.

The user input unit 80 may receive information input from the user, or may output information to the user. Examples of the user input unit 80 may include a key pad, a dome switch, a touch pad (a contact capacitance type, a pressure resistive film type, an infrared sensing type, a surface ultrasonic conduction type, an integral tension measurement type, a piezo effect type, etc.), a jog wheel, a jog switch, and the like, but the present disclosure is not limited thereto.

The controller 100 may control the operation of the heating unit 50 and the sensing unit 60. The controller 100 may store information in a memory 102. The controller 100 may store information in the memory 102 or may retrieve stored information from the memory 102. The memory 102, which is hardware for storing various data processed in the aerosol generating device 1, may store data processed by the controller 100 and data to be processed by the controller 100. The memory 102 may include at least one type of storage medium among a flash memory type, a hard disk type, a multimedia card micro type, card-type memory (e.g., SD or XD memory), random access memory (RAM), static random-access memory (SRAM), read-only memory (ROM), electrically erasable programmable read-only memory (EEPROM), programmable read-only memory (PROM), magnetic memory, a magnetic disk, and an optical disk.

The power source 101 may supply power to the aerosol generating device 1. The power source 101 may apply an AC voltage to the plurality of coils 51, 52, and 53. The power source 101 may apply a DC voltage to the plurality of coils 51, 52, and 53. The power source 101 may be connected to the outside through the terminal 103. The power source 101 may be a rechargeable battery or a disposable battery. For example, the power source 101 may be a lithium polymer (LiPoly) battery, but the present disclosure is not limited thereto.

The power source 101 may include at least one switch (not shown). The switch may regulate electrical energy supplied to the plurality of coils 51, 52, and 53. The power source 101 may individually supply electrical energy to each of the plurality of coils 51, 52, and 53 through the switch.

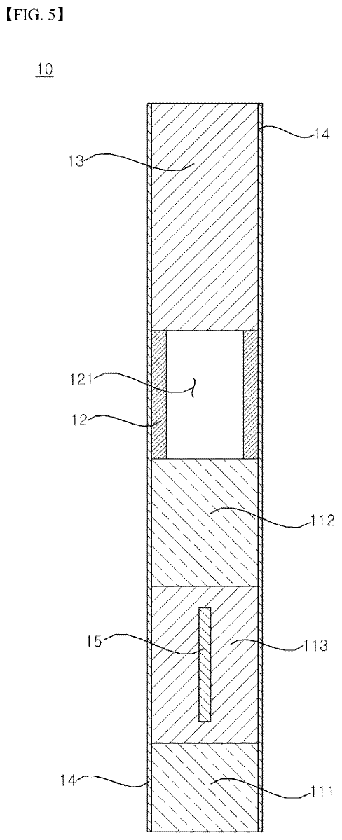

FIGS. 4 and 5 illustrate the stick 10 according to an embodiment of the present disclosure. Referring to FIGS. 4 and 5, the stick 10 may be elongated. For example, the stick 10 may have a cylindrical shape, and may have a circular cross section. The stick 10 may include a medium portion 11, a cooling portion 12, a filter portion 13, a wrapper 14, and the susceptor 15. The medium portion 11, the cooling portion 12, and the filter portion 13 may be arranged sequentially.

The cooling portion 12 may be disposed between the medium portion 11 and the filter portion 13. The wrapper 14 may wrap the medium portion 11, the cooling portion 12, and the filter portion 13. The medium portion 11 may include a medium 113. The medium portion 11 may include a first medium cover 111. The medium portion 11 may include a second medium cover 112. The medium 113 may be disposed between the first medium cover 111 and the second medium cover 112. The first medium cover 111 may be disposed at one end of the stick 10. The medium portion 11 may have a length of 24 mm.

The medium 113 may be vaporized and/or atomized into an aerosol using heat supplied from the susceptor 15. The medium 113, which is an aerosol generating substance, may include a multicomponent substance. For example, the substance contained in the medium 113 may be a multicomponent flavoring substance. The medium 113 may emit fragrance or aroma when receiving heat from the susceptor 15. For example, the medium 113 may be made of a plurality of granules. Each of the plurality of granules may have a size of 0.4 mm to 1.12 mm. The medium 113 may have a length L2 of 10 mm.

The first medium cover 111 may be made of an acetate material. The second medium cover 112 may be made of an acetate material. The first medium cover 111 may be made of a paper material. The second medium cover 112 may be made of a paper material. At least one of the first medium cover 111 and the second medium cover 112 may be made of a paper material to be crumpled with wrinkles, and a plurality of gaps through which air flows may be formed between the wrinkles. Each of the plurality of gaps may be smaller in size than each of the granules of the medium 113. A length L1 of the first medium cover 111 may be less than the length L2 of the medium 113. A length L3 of the second medium cover 111 may be less than the length L2 of the medium 113. The length L1 of the first medium cover 111 may be 7 mm. The length L3 of the second medium cover 111 may be 7 mm.

Accordingly, separation of each granule of the medium 113 from the medium portion 11 and the stick 10 may be prevented.

The cooling portion 12 may have a cylindrical shape. The cooling portion 12 may have a hollow shape. The cooling portion 12 may be disposed between the medium portion 11 and the filter portion 13. The cooling portion 12 may be disposed between the second medium cover 112 and the filter portion 13. The cooling portion 12 may have the shape of a tube surrounding a cooling path 121 formed therein. The cooling portion 12 may have a greater thickness than the wrapper 14. The cooling portion 12 may be made of a paper material thicker than that of the wrapper 14. A length L4 of the cooling portion 12 may be equal or similar to the length L2 of the medium 113. The length L4 of each of the cooling portion 12 and the cooling path 121 may be 10 mm. When the stick 10 is inserted into the aerosol generating device 1 (see FIG. 1), at least a portion of the cooling portion 12 may be exposed to the outside of the aerosol generating device 1.

Accordingly, the cooling portion 12 may support the medium portion 11 and the filter portion 13, thereby achieving the rigidity of the stick 10. In addition, the cooling portion 12 may support the wrapper 14 between the medium portion 11 and the filter portion 13, and may provide a portion or region to which the wrapper 14 can be adhered. In addition, heated air and aerosol may be cooled while passing through the cooling path 121 in the cooling portion 12.

The filter portion 13 may be configured as a filter made of an acetate material. The filter portion 13 may be disposed at another (or opposite) end of the stick 10. When the stick 10 is inserted into the aerosol generating device 1 (see FIG. 1), the filter portion 13 may be exposed to the outside of the aerosol generating device 1. A user may inhale air while holding the filter portion 13 in his or her mouth. A length L5 of the filter portion 13 may be 14 mm.

The wrapper 14 may wrap or surround the medium portion 11, the cooling portion 12, and the filter portion 13. The wrapper 14 may define an outer shape of the stick 10. The wrapper 14 may be made of a paper material. An adhesive portion 143 may be formed at one edge of the wrapper 14. The wrapper 14 may wrap the medium portion 11, the cooling portion 12 and the filter portion 13, and the adhesive portion 143 formed at the one edge and another edge of the wrapper 14 may be adhered to each other. The wrapper 14 may surround the medium portion 11, the cooling portion 12, and the filter portion 13, but may not cover one end and another end of the stick 10. Accordingly, the wrapper 14 may surround the outside of the medium portion 11, the cooling portion 12, and the filter portion 13.

The medium 113 and the susceptor 15 may be disposed on one side of the stick 10. The susceptor 15 may be embedded in the medium 113. For example, the susceptor 15 may be disposed at an inner middle of the medium 113.

The susceptor 15 may be inductively heated by the plurality of coils 51, 52, and 53. As the susceptor 15 is heated by induction, heat may be provided to the medium 113. The susceptor 15 may have a shape with an orientation or directionality. For example, the susceptor 15 may have a plate shape. Therefore, when the stick 10 is inserted into the insertion space 42, a disposition direction DD of the susceptor 15 having directionality may be different from a predetermined disposition direction, and a degree of induction heating of the susceptor 15 by the plurality of coils 51, 52, and 53 may vary.

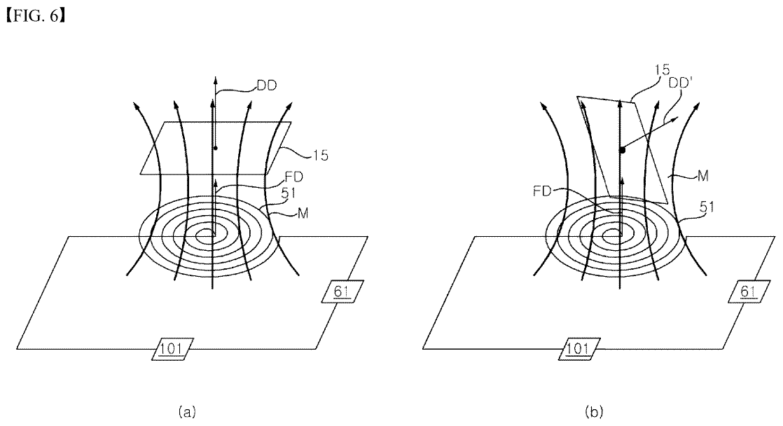

FIG. 6 shows that the susceptor 15 is inductively heated by the first coil 51. Although the first coil 51 is used as an example in FIG. 6, this may be equally applied to the second coil 52 and the third coil 53.

Referring to FIG. 6, the heating unit 50 supplied with electrical energy from the power source 101 may generate an induced magnetic field M. The induced magnetic field M may pass through the susceptor 15. The susceptor 15 may be inductively heated by the induced magnetic field M. The sensing unit 60 may measure a current value flowing through the heating unit 50.

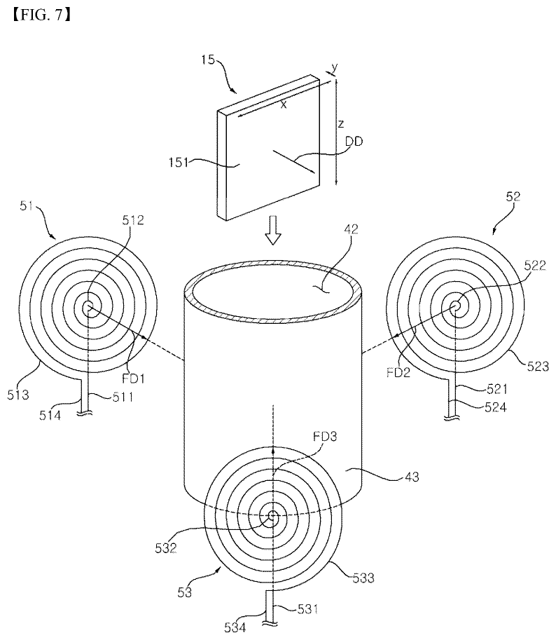

The first coil 51 may be configured as a pan coil consisting of a plurality of turns including an innermost turn 512 (see FIG. 7) and an outermost turn 513 (see FIG. 7). As shown in FIG. 6, a direction FD that the first coil 51 faces may be defined based on the shape of the first coil 51. A disposition direction DD of the susceptor 15 to which the susceptor 15 is directed may be defined based on the placement of the susceptor 15.
(a) of FIG. 6 illustrates an example in which the susceptor 15 and the first coil 51 face each other. In (a) of FIG. 6, the direction FD that the first coil 51 faces and the disposition direction DD of the susceptor 15 are aligned with each other. An induced magnetic field M generated by the first coil 51 may inductively heat the susceptor 15.
(b) of FIG. 6 illustrates an example in which the disposition direction DD of the susceptor 15 is changed (different) from that of (a) of FIG. 6. A disposition direction DD′ of the susceptor 15 and the direction FD that the first coil 51 faces may intersect each other. As for (b) of FIG. 6, only part of the induced magnetic field M generated by the first coil 51 may pass through the susceptor 15 compared to (a) of FIG. 6. In other words, when the same electrical energy is supplied to the first coil 51, the degree of induction heating of the susceptor 15 may be different due to the change in the disposition direction DD of the susceptor 15.

FIG. 7 illustrates a part of the aerosol generating device 1 according to an embodiment of the present disclosure. Referring to FIG. 7, the first coil 51 may include a first wire 511, the innermost turn 512, the outermost turn 513, and a second wire 514.

The first wire 511 may connect the power source 101 and the innermost turn 512. The first coil 51 may be wound a plurality of times from the innermost turn 512 to the outermost turn 513. The second wire 514 may connect the power supply 101 and the outermost turn 513. The first coil 51 may be configured as a pan coil.

The second coil 52 may include a third wire 521, an innermost turn 522, an outermost turn 523, and a fourth wire 524. The third wire 521 may connect the power source 101 and the innermost turn 522. The second coil 52 may be wound a plurality of times from the innermost turn 522 to the outermost turn 523. The fourth wire 524 may connect the power source 101 and the outermost turn 523. The second coil 52 may be configured as a pan coil.

The third coil 53 may include a fifth wire 531, an innermost turn 532, an outermost turn 533, and a sixth wire 534. The fifth wire 531 may connect the power source 101 and the innermost turn 532. The third coil 53 may be wound a plurality of times from the innermost turn 532 to the outermost turn 533. The sixth wire 534 may connect the power supply 101 and the outermost turn 533. The third coil 53 may be configured as a pan coil.

Meanwhile, the first wire 511 and the second wire 514 may be disposed adjacent to each other in one region of the outermost turn 513. The first wire 511 and the second wire 514 may extend from the one region of the outermost turn 513 toward the power source 101. The third wire 521 and the fourth wire 524 may be disposed adjacent to each other in one region of the outermost turn 523. The third wire 521 and the fourth wire 524 may extend from the one region of the outermost turn 523 toward the power source 101. The fifth wire 531 and the sixth wire 534 may be disposed adjacent to each other in one region of the outermost turn 533. The fifth wire 531 and the sixth wire 534 may extend from the one region of the outermost turn 533 toward the power source 101.

The first coil 51 may face the lateral part 43 of the inner wall (43, 45). The second coil 52 may face the lateral part 43 of the inner wall (43, 45). The third coil 53 may face the lateral part 43 of the inner wall (43, 45). The first coil 51, the second coil 52, and the third coil 53 may surround at least a portion of the lateral part 43 of the inner wall (43, 45).

The susceptor 15 may be inserted into the insertion space 42. The shape of the susceptor 15 may be defined by a first width x, a second width y, and a third width z that extend in directions orthogonal to each other. At least two of the first width x, the second width y, and the third width z of the susceptor 15 may be different from each other. For example, the susceptor 15 may have a plate shape as shown in FIG. 7. However, the shape of the susceptor 15 is not limited to the plate shape.

FIG. 7 illustrates an example in which the first width x is different from the second width y, and the second width y is different from the third width z. One surface 151 of the susceptor 15 may face the lateral part 43 of the inner wall (43, 45). The first width x and the third width z that determine the size of the one surface 151 of the susceptor 15 may be greater than the second width y. The disposition direction DD of the susceptor 15 may be defined based on the one surface 151 of the susceptor 15.

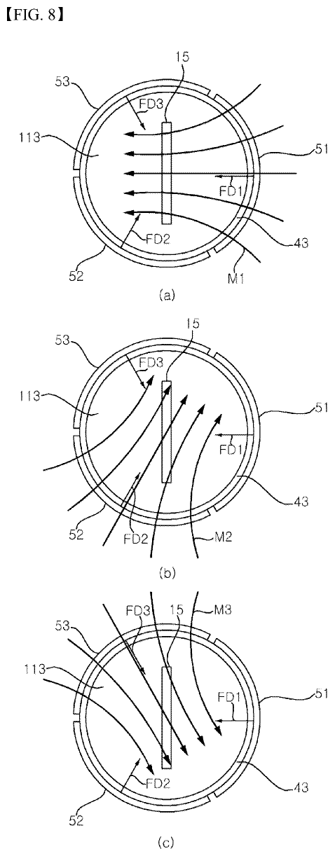

FIG. 8 shows that the susceptor 15 embedded in the medium 113 is inductively heated by the plurality of coils 51, 52, and 53. Referring to FIG. 8, the susceptor 15 may face the lateral part 43 of the inner wall (43, 45). The plurality of coils 51, 52, and 53 may face the lateral part 43 of the inner wall (43, 45). The susceptor 15 may be inserted into the insertion space 42 to be disposed to face the first coil 51. Unlike shown in FIG. 8, the susceptor 15 may be inserted into the insertion space 42 to be disposed to face the second coil 52 or the third coil 53, or alternatively, to be disposed so as not to face any of the plurality of coils 51, 52, and 53.

A first induced magnetic field M1 may be generated by the first coil 51. A second induced magnetic field M2 may be generated by the second coil 52. A third induced magnetic field M3 may be generated by the third coil 53.

A direction FD1 that the first coil 51 faces may intersect a direction FD2 that the second coil 52 faces. The direction FD2 that the second coil 52 faces may intersect a direction FD3 that the third coil 53 faces. The direction FD1 that the first coil 51 faces may intersect the direction FD3 that the third coil 53 faces.

When comparing (a) of FIG. 8 with (b) and (c) of FIG. 8, relatively part of the second induced magnetic field M2 generated by the second coil 52 and the third induced magnetic field M3 generated by the third coil 53 passes through the susceptor 15 relative to the first induced magnetic field M1 generated by the first coil 51. Therefore, among the first coil 51, the second coil 52, and the third coil 53, the first coil 51 may be most suitable for induction heating of the susceptor 15.

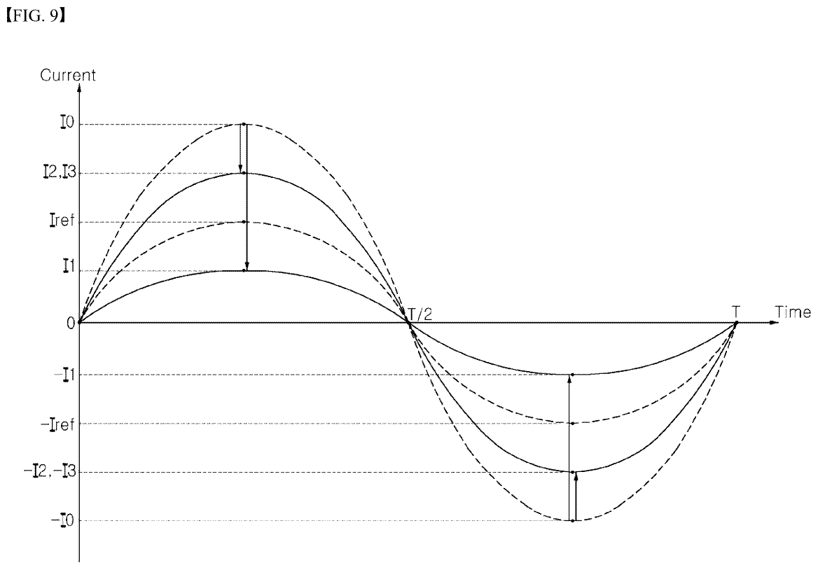

FIG. 9 shows a change in alternating current value during one period T measured by the sensing unit 60 when an AC voltage is applied to the heating unit 50. Referring to FIG. 9, when the stick 10 is inserted into the insertion space 42 and an AC voltage is applied to the heating unit 50, the susceptor 15 may be inductively heated by an induced magnetic field. Here, the extent to which current values I1, I2, and I3 flowing through the respective coils 51, 52, and 53 is reduced from an initial current value I0 may vary according to the degree of induction heating of the susceptor 15.

The initial current value I0 may refer to a current value flowing through each of the coils 51, 52, and 53 when a reference voltage is applied to each of the coils 51, 52, and 53. That is, the initial current value I0 may be defined as a current value measured by each of the current sensors 61, 62, and 63 when the reference voltage is applied to each of the coils 51, 52, and 53 while the stick 10 is not inserted into the insertion space 42. The initial current value I0 may be measured before the insertion of the stick 10, or may be a predetermined (or preset) value stored in the memory 102.

Meanwhile, in the case of the alternating current, the measured current value described herein is based on the peak value, but may also be described based on the mean value, the root mean square value, and the like. Therefore, the idea and technical scope of the present disclosure is not limited to the case where the measured current value is the peak value.

FIGS. 8 and 9 show a state in which the stick 10 is inserted into the insertion space 42. Referring to FIGS. 8 and 9, when the reference voltage is applied to the first coil 51 by the power source 101, a first current value I1 sensed by the first current sensor 61 may be less than the initial current value I0. When the reference voltage is applied to the second coil 52 by the power source 101, a second current value I2 sensed by the second current sensor 62 may be less than the initial current value I0. When the reference voltage is applied to the third coil 53 by the power source 10, a third current value I3 sensed by the third current sensor 63 may be less than the initial current value I0. A difference between the first current value I1 and the initial current value I0 may be greater than a difference between the second current value I2 and the initial current value I0. The difference between the first current value I1 and the initial current value I0 may be greater than a difference between the third current value I3 and the initial current value I0.

A predetermined reference current value I.ref may be a reference value for determining a suitable coil for induction heating of the susceptor 15. That is, when the reference voltage is applied, a coil through which a current less than the predetermined reference current value I.ref flows may be more efficient in induction heating of the susceptor 15 than a coil through which a current greater than the predetermined reference current value I.ref flows.

The first current value I1 may be less than the predetermined reference current value I.ref. The second current value I2 may be greater than the predetermined reference current value I.ref. The third current value I3 may be greater than the predetermined reference current value I.ref. That is, the first coil 51 may be more efficient in induction heating of the susceptor 15 than the second coil 52 and the third coil 53.

Meanwhile, the predetermined reference current value I.ref may be individually preset for each of the coils 51, 52, and 53. When the predetermined reference current value I.ref is individually set for each of the coils 51, 52, and 53, deviations due to differences in physical properties between the coils 51, 52, and 53 may be considered in determining the most suitable coil for induction heating of the susceptor 15.

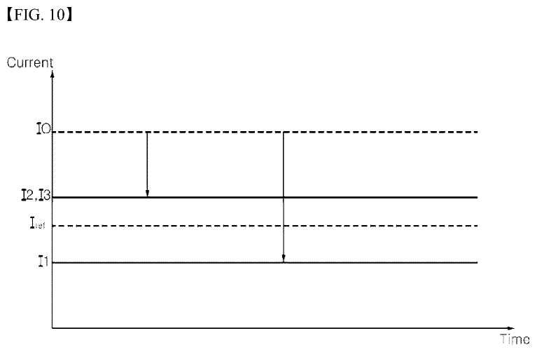

FIG. 10 shows current values flowing through the respective coils 51, 52, and 53, which are measured by the sensing unit 60, when a DC voltage is applied to the heating unit 50 by the power supply 101. Referring to FIG. 10, when the reference voltage is applied to the first coil 51 by the power source 101, a first current value I1 sensed by the first current sensor 61 may be less than an initial current value I0. When the reference voltage is applied to the second coil 52 by the power source 101, a second current value I2 sensed by the second current sensor 62 may be less than the initial current value I0. When the reference voltage is applied to the third coil 53 by the power source 101, a third current value I3 sensed by the third current sensor 63 may be less than the initial current value I0. A difference between the first current value I1 and the initial current value I0 may be greater than a difference between the second current value I2 and the initial current value I0. The difference between the first current value I1 and the initial current value I0 may be greater than a difference between the third current value I3 and the initial current value I0.

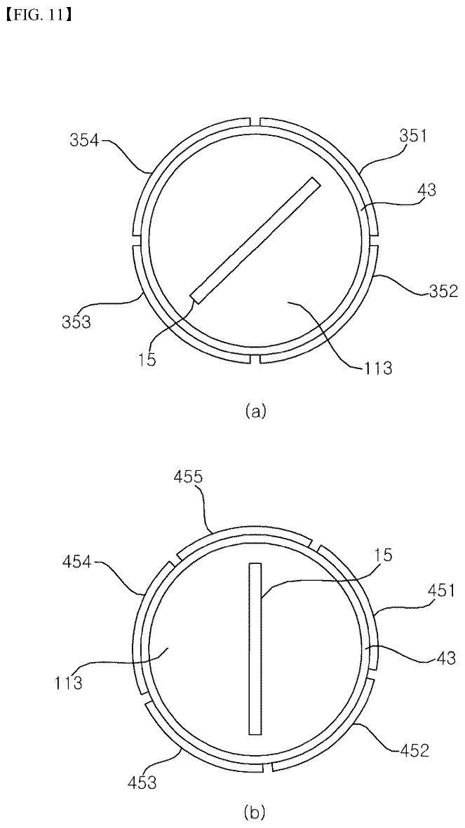

The first current value I1 may be less than a predetermined reference current value I.ref. The second current value I2 may be greater than the predetermined reference current value I.ref. The third current value I3 may be greater than the predetermined reference current value I.ref. That is, the first coil 51 may be more efficient in induction heating of the susceptor 15 than the second coil 52 and the third coil 53.
(a) and (b) of FIG. 11 illustrate various embodiments of a part of the aerosol generating device 1. Referring to (a) of FIG. 11, a plurality of coils 351, 352, 353, and 354 that surround the lateral part 43 of the inner wall (43, 45) may be provided in an even number. Of the coils 351 and 352 that do not face each other, the coil 352 may be determined as a suitable coil for induction heating of the susceptor 15, and a voltage may be applied to both the coil 352 determined as the suitable coil and the coil 354 facing the coil 352 so as to inductively heat the susceptor 15 in an effective manner. That is, any one of two coils 352 and 354 facing each other may be determined as a suitable coil for induction heating of the susceptor 15 to apply a voltage to both the coil 352 determined as the suitable coil and the coil 354 facing the suitable coil 352, allowing the susceptor 15 to be inductively heated in an effective manner.

Referring to (b) of FIG. 11, a plurality of coils 451, 452, 453, 454, and 455 may be provided in an odd number. For example, five coils 451, 452, 453, 454, and 455 may be provided. The plurality of coils 451, 452, 453, 454, and 455 may surround the lateral part 43 of the inner wall (43, 45). As the number of coils is increased, induced magnetic fields that pass through the susceptor 15 at various positions may be generated.

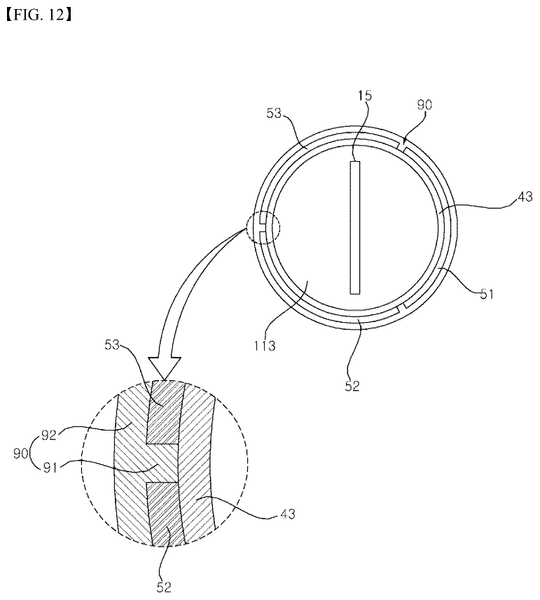

FIG. 12 illustrates a shielding member 90 according to an embodiment of the present disclosure. Referring to FIG. 12, a shielding member 90 may include a first shielding member 91 and a second shielding member 92. The shielding member 90 may also be referred to as a shielding unit 90.

The first shielding member 91 may be disposed between the coils 52 and 53 adjacent to each other. The first shielding member 91 may be disposed between the coils 52 and 53 adjacent to each other in a circumferential direction of the lateral part 43 of the inner wall (43, 45). The first shielding member 91 may be disposed between the first coil 51 and the second coil 52. The first shielding member 91 may be disposed between the second coil 52 and the third coil 53. The first shielding member 91 may be disposed between the third coil 53 and the first coil 51.

The second shielding member 92 may surround the plurality of coils 51, 52, and 53. The second shielding member 92 may be connected to the first shielding member 91. The second shielding member 92 may be integrally formed with the first shielding member 91. The plurality of coils 51, 52, and 53 may be disposed between the second shielding member 92 and the lateral part 43 of the inner wall (43, 45).

Due to the first shielding member 91 and the second shielding member 92, influence by an induced magnetic field generated by any one of the coils 51, 52, and 53 on the other or remaining coils (51, 52, 53) may be prevented. In addition, the first shielding member 91 may maintain a distance between each of the plurality of coils 51, 52, and 53. Also, the second shielding member 92 may support the lateral part 43 of the inner wall (43, 45) to prevent the plurality of coils 51, 52, and 53 from being away from the lateral part 43 of the inner wall (43, 45).

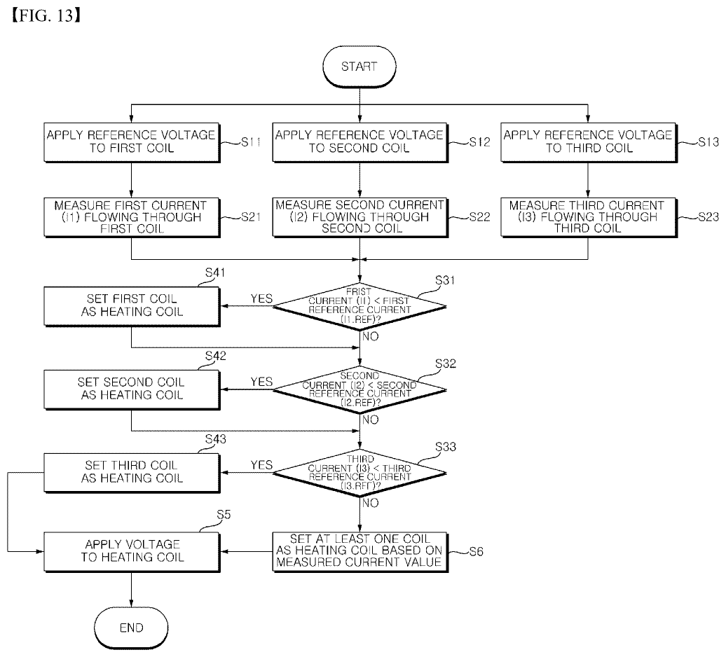

FIG. 13 illustrates a method for controlling the aerosol generating device 1 according to an embodiment of the present disclosure. Referring to FIG. 13, based on the method for controlling the aerosol generating device 1, at least one heating coil among the plurality of coils 51, 52, and 53 may be determined to apply a voltage to the heating coil, so as to inductively heat the susceptor 15.

The heating coil may refer to a coil, among the plurality of coils 51, 52, and 53, which is used to inductively heat the susceptor 15 by receiving electricity from the power source 101. The controller 100 may set or determine at least one heating coil among the plurality of coils 51, 52, and 53.

The method for controlling the aerosol generating device 1 according to this embodiment may include applying the reference voltage to each of the plurality of coils 51, 52 and 53 (S11, S12, and S13), and measuring currents 11, 12, and 13 respectively flowing through the plurality of coils 51, 52, and 53 with respect to the reference voltage (S21, S22, and S23).

When the reference voltage is applied to each of the plurality of coils 51, 52, and 53, the measured currents I1, I2, and I3 may be different from each other according to the degree of induction heating of the susceptor 15 by induced magnetic fields generated by the respective plurality of coils 51, 52, and 53.

The process of applying the reference voltage to each of the coils 51, 52 and 53, and measuring the corresponding currents I1, I2, and I3 may be performed simultaneously or sequentially.

The method for controlling the aerosol generating device 1 according to this embodiment may include comparing the measured currents I1, I2, and I3 with a reference current value I.ref (S31, S32, and S33), and determining the heating coil (S41, S42, S43).

The controller 100 may compare the measured first current I1 and a first reference current I1.ref (S31). When the measured first current I1 is less than the first reference current I1.ref, the controller 100 may set or determine the first coil 51 as the heating coil (S41).

The controller 100 may compare the measured second current I2 and a second reference current I2.ref (S32). When the measured second current I2 is less than the second reference current I2.ref, the controller 100 may set or determine the second coil 52 as the heating coil (S42).

The controller 100 may compare the measured third current I3 and a reference current I3.ref (S33). When the measured third current I3 is less than the reference current I3.ref, the controller 100 may set or determine the third coil 53 as the heating coil (S43).

The method for controlling the aerosol generating device 1 according to this embodiment may include applying a voltage to the heating coil (S5) and determining part of the plurality of coils 51, 52, and 53 as the heating coil (S6).

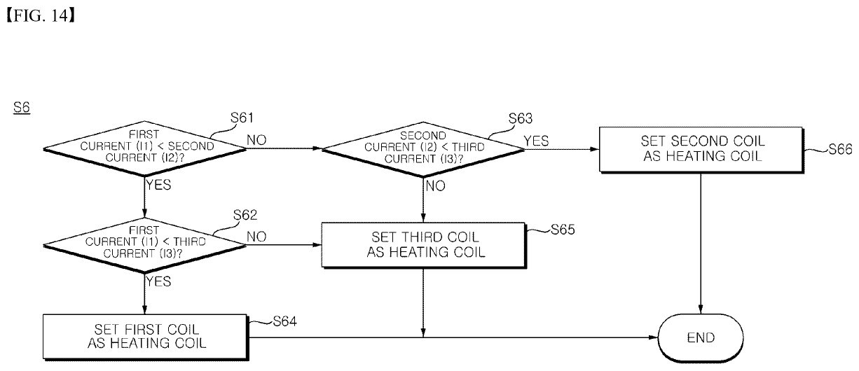

The step S5 of applying the voltage to the heating coil may be applying a voltage to the set heating coil so as to inductively heat the susceptor 15 (S5). The step S6 of setting part of the plurality of coils 51, 52, and 53 as the heating coil will be described in detail with reference to FIG. 14.

FIG. 14 illustrates a step of setting part of the plurality of coils 51, 52, and 53 as the heating coil (S6). The step S6 of setting part of the plurality of coils 51, 52, and 53 as the heating coil may be performed when the first current Il is greater than the first reference current I1.ref, the second current I2 is greater than the second reference current I2.ref, and the third current I3 is greater than the third reference current I3.ref.

The controller 100 may compare the first current I1, the second current I2, and the third current I3 to set, among the plurality of coils 51, 52 and 53, a coil having the lowest measured current (I1, I2, I3) as the heating coil.

For example, when the first current I1 is less than the second current I2 (S61) and the first current I1 is less than the third current I3 (S62), the controller 100 may set the first coil 51 as the heating coil (S64). For example, when the first current I1 is greater than the second current I2 (S61) and the second current I2 is less than the third current I3 (S63), the controller 100 may set the second coil 52 as the heating coil (S66). For example, when the first current I1 is less than the second current I2 (S61) and the first current I1 is greater than the third current I3 (S62), the controller 100 may set the third coil 53 as the heating coil (S65). For example, when the first current I1 is greater than the second current I2 (S61) and the second current I2 is greater than the third current I3 (S63), the controller 100 may set the third coil 53 as the heating coil (S65).

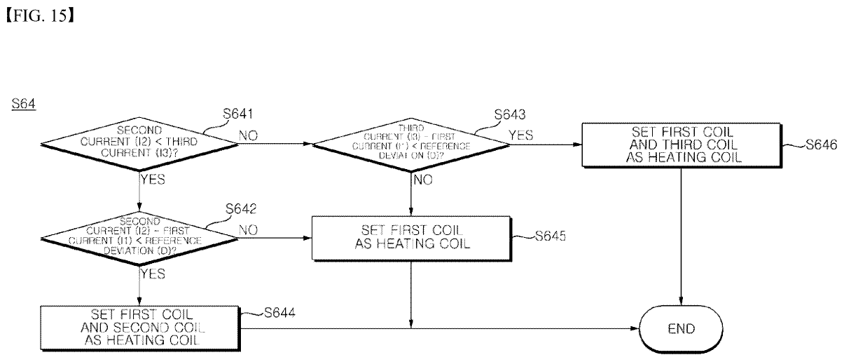

Referring to FIGS. 15 to 17, the controller 100 may additionally set, based on a current value difference between a coil, among the plurality of coils 51, 52 and 53, having the lowest measured current value (I1, I2, I3) and each remaining coil, a coil having a current value difference less than a reference deviation d as the heating coil. Meanwhile, the reference deviation d may be a value stored in the memory 102. The reference deviation d may be a predetermined current value.

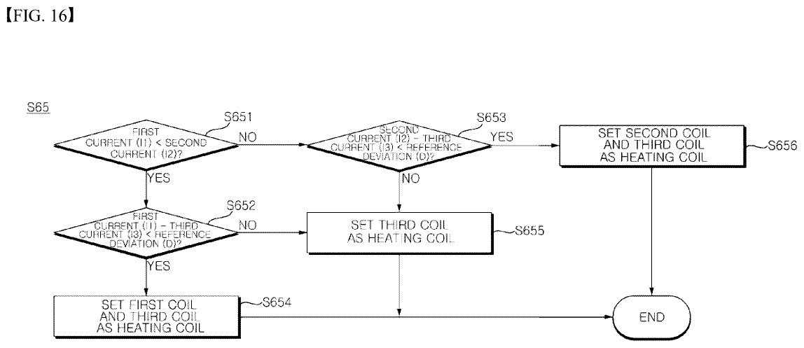

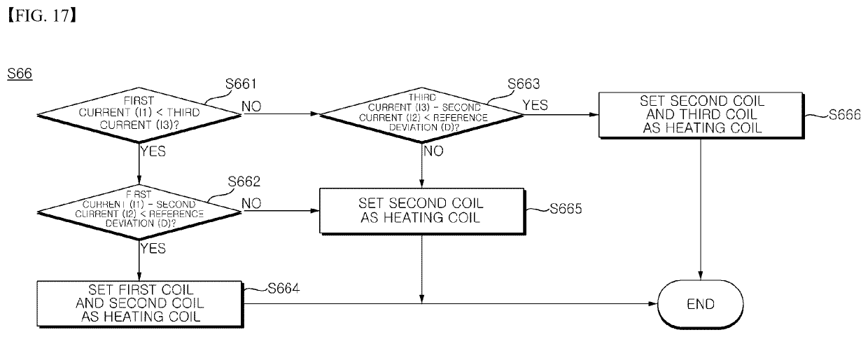

FIG. 15 illustrates a step of additionally setting the second coil 52 or the third coil 53 as the heating coil when the first current Il is the lowest. FIG. 16 illustrates a step of additionally setting the first coil 51 or the second coil 52 as the heating coil when the third current I3 is the lowest. FIG. 17 illustrates a step of additionally setting the first coil 51 or the third coil 53 as the heating coil when the second current I2 is the lowest.

In one example, referring to FIG. 15, except the first current I1, which is the lowest value among the measured currents I1, I2 and I3, the second current I2 and the third current I3 are compared to determine which one is greater and which one is less (S641). When the second current I2 is less than the third current I3 (S641) and a difference between the second current I2 and the first current I1 is less than the reference deviation d (S642), the controller 100 may set the first coil 51 and the second coil 52 as the heating coil (S644). When the second current I2 is greater than the third current I3 (S641) and a difference between the third current I3 and the first current I1 is less than the reference deviation d (S643), the controller 100 may set the first coil 51 and the third coil 53 as the heating coil (S646). When the difference between the second current I2 and the first current I1 is greater than the reference deviation d (S642) or the difference between the third current I3 and the first current I1 is greater than the reference deviation d (S643), the controller 100 may set the first coil 51 as the heating coil (S645).

In another example, referring to FIG. 16, except the third current I3, which is the lowest value among the measured currents I1, I2 and I3, the first current I1 and the second current I2 are compared to determine which one is greater and which one is less (S651). When the first current I2 is less than the second current I2 (S651) and a difference between the first current I1 and the third current I3 is less than the reference deviation d (S652), the controller 100 may set the first coil 51 and the third coil 53 as the heating coil (S654). When the first current I1 is greater than the second current I2 (S651) and a difference between the second current I2 and the third current I3 is less than the reference deviation d (S653), the controller 100 may set the second coil 52 and the third coil 53 as the heating coil (S656). When the difference between the first current I1 and the third current I3 is greater than the reference deviation d (S652) or the difference between the second current I2 and the third current I3 is greater than the reference deviation d (S653), the controller 100 may set the third coil 53 as the heating coil (S655).

In another example, referring to FIG. 17, except the second current I2, which is the lowest value among the measured currents I1, I2 and I3, the first current I1 and the third current I3 are compared to determine which one is greater and which one is less (S661). When the first current I1 is less than the third current I3 (S661) and a difference between the first current I1 and the second current I2 is less than the reference deviation d (S662), the controller 100 may set the first coil 51 and the second coil 52 as the heating coil (S664). When the first current I1 is greater than the third current I3 (S661) and a difference between the third current I3 and the second current I2 is less than the reference deviation d (S663), the controller 100 may set the second coil 52 and the third coil 53 as the heating coil (S666). When the difference between the first current I1 and the second current I2 is greater than the reference deviation d (S662) or the difference between the third current I3 and the second current I2 is greater than the reference deviation d (S663), the controller 100 may set the second coil 52 as the heating coil (S665).

Referring to FIGS. 1 to 17, according to one aspect of the present disclosure, an aerosol generating device 1 configured to receive a stick 10 having one side provided with an aerosol generating substance 113 and a susceptor 15 is provided. The aerosol generating device 1 may include: a housing 40 including an inner wall (43, 45) that has one end 43e open and defines therein an insertion space 42 into which the one side of the stick 10 is inserted, and an outer wall 46 that surrounds the inner wall (43, 45); a plurality of coils 51, 52, and 53 disposed between the inner wall (43, 45) and the outer wall 46 of the housing 40, and configured to inductively heat the susceptor 15 disposed in the insertion space 42; a power source 101 electrically connected to the plurality of coils 51, 52 and 53; and a controller 100 configured to apply a reference voltage to the plurality of coils 51, 52 and 53, and to apply, based on current values flowing through the respective plurality of coils 51, 52, and 53 when the reference voltage is applied, a voltage to at least one heating coil having a current value less than or equal to a predetermined reference current value I.ref.

According to another aspect of the present disclosure, when all the current values I1, I2, and I3 measured in the plurality of coils 51, 52, and 53 exceed the predetermined reference current value I.ref, the controller 100 may apply a voltage to a coil having a lowest measured current value (I1, I2, I3) among the plurality of coils 51, 52, and 53.

According to another aspect of the present disclosure, when all the current values I1, I2, and I3 measured in the plurality of coils 51, 52, and 53 exceed the predetermined reference current value I.ref, the controller 100 may apply, based on a current value difference between a coil, among the plurality of coils 51, 52 and 53, having a lowest measured current value (I1, I2, I3) and each remaining coil, a voltage to the coil having the lowest measured current value (I1, I2, I3) and at least one coil having a current value difference less than a reference deviation d.

According to another aspect of the present disclosure, the predetermined reference current value (I1.ref, I2.ref, I3.ref) may be individually set for each of the plurality of coils 51, 52, and 53.

According to another aspect of the present disclosure, the plurality of coils 51, 52, and 53 may be disposed adjacent to the inner wall (43, 45).

According to another aspect of the present disclosure, the plurality of coils 51, 52, and 53 may each be configured as a pan coil that is wound a plurality of times from an innermost turn (512, 522, 532) to an outermost turn (513, 523, 533) and faces the inner wall (43, 45).

According to another aspect of the present disclosure, the plurality of coils 51, 52, and 53 may be configured such that directions FD1, FD2, and FD3 facing the inner wall 43 intersect each other.

According to another aspect of the present disclosure, the inner wall (43, 45) may include a lateral part 43 that extends from the one end 43e in a longitudinal direction of the inner wall 43 and faces the plurality of coils 51, 52, and 53. The susceptor 15 may have a plate shape, and may be inserted into the insertion space 42 to be disposed to face the inner wall (43, 45). The plurality of coils 51, 52, and 53 may be sequentially arranged in a circumferential direction of the lateral part 43 of the inner wall (43, 45).

According to another aspect of the present disclosure, the aerosol generating device 1 may further include a first shielding member 91 disposed between adjacent coils among the plurality of coils 51, 52, and 53.

According to another aspect of the present disclosure, the aerosol generating device 1 may further include a second shielding member 92 that is disposed between the inner wall (43, 45) and the outer wall 46 of the housing 40, surrounds the plurality of coils 51, 52 and 53, and is connected to the first shielding member 91.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device configured to receive a stick comprising an aerosol generating substance and a susceptor, the aerosol generating device comprising:
a housing comprising an opening to an inner wall defining therein an insertion space configured to accommodate insertion of the stick, wherein the housing further comprises an outer wall surrounding the inner wall;
a plurality of coils disposed between the inner wall and the outer wall of the housing and configured to inductively heat the susceptor inserted in the insertion space;
a power source electrically connected to the plurality of coils; and
a controller configured to:
cause the power source to apply a reference voltage to the plurality of coils;
measure respective current values flowing through each of the plurality of coils based on the reference voltage; and
cause the power source to apply a voltage to at least one coil of the plurality of coils having the measured current value less than or equal to a predetermined reference current value.

2. The aerosol generating device of claim 1, wherein the controller is further configured to, based on all measured current values of the plurality of coils being greater than the predetermined reference current value, cause the power source to apply the voltage to a coil having a lowest measured current value.

3. The aerosol generating device of claim 1, wherein the controller is further configured to, based on all measured current values being greater than the predetermined reference current value, cause the power source to apply the voltage to a coil having a lowest measured current value and to at least one additional coil having a measured current value less than a reference deviation from the lowest measured current value.

4. The aerosol generating device of claim 1, wherein the predetermined reference current value is individually set for each of the plurality of coils.

5. The aerosol generating device of claim 1, wherein the plurality of coils are disposed adjacent to the inner wall.

6. The aerosol generating device of claim 1, wherein the plurality of coils are each configured as a pan coil that is wound a plurality of times from an innermost turn to an outermost turn and faces the inner wall.

7. The aerosol generating device of claim 6, wherein the plurality of coils are configured such that respective facing directions of each coil intersect each other.

8. The aerosol generating device of claim 6, wherein the plurality of coils are arranged in a circumferential direction of the inner wall to inductively heat the susceptor having a plate shape.

9. The aerosol generating device of claim 6, further comprising a first shielding member disposed between adjacent coils among the plurality of coils.

10. The aerosol generating device of claim 9, further comprising a second shielding member connected to the first shielding member and disposed between the inner wall and the outer wall of the housing to surround the plurality of coils.
